(19) United States
(12) Patent Application Publication
(10) Pub. No.: US 2011/0047471 A1
(43) Pub. Date: Feb. 24, 2011

(54) Apparatus and Methods for Associating a User's Activity in Relation to a Physical Location with a Virtual Community

(75) Inventors: Max Lord, Boston, MA (US); Stephen Randall, Wellesley, MA (US); Stephen H. An, Boston, MA (US); Matt St. Gelais, South Boston, MA (US); Masumi Nakamura, Cambridge, MA (US)

Correspondence Address: Sunstein Kann Murphy & Timbers LLP, 125 SUMMER STREET, BOSTON, MA, 02110-1618, US

(73) Assignee: LOCAMODA, INC., Cambridge, MA (US)

(21) Appl. No.: 12/919,057

(22) PCT Filed: Feb. 25, 2009
(86) PCT No.: PCT/US09/35146

§ 371 Date: Nov. 10, 2010

Related U.S. Application Data
(60) Provisional application No. 61/031,332, filed on Feb. 25, 2008.

(51) Int. Cl. G06F 3/048; G06F 15/16; G06F 3/00

(52) U.S. Cl. 715/739; 709/206; 715/744

(57) ABSTRACT

A system permits a user's activity in relation to a physical location to be associated with a virtual community web site and, therefore, with a virtual community created by the web site. Users indicate their presence at, or association with, a physical location by sending messages from their personal communication devices, such as mobile telephones or Internet-connected computers. Users may participate in activities at the locations by sending such messages, accessing location proxy web sites or via virtual communities. An exemplary activity includes a network-connected jukebox. Users may obtain information about music being played on the jukebox. In addition, the jukebox may display information about music being played on other jukeboxes, possibly in other locations.

### CROSS REFERENCE TO RELATED APPLICATIONS

This application claims the benefit of U.S. Provisional Patent Application No. 61/031,332, filed Feb. 25, 2008, titled “Apparatus and Methods for Associating a User's Activity in Relation to a Physical Location with a Virtual Community,” the entire contents of which are hereby incorporated by reference herein, for all purposes. This application is a national phase application from International Patent Application No. PCT/US2009/035146, titled “Apparatus and Methods for Associating a User's Activity in Relation to a Physical Location with a Virtual Community,” filed Feb. 25, 2009 and having a priority date of Feb. 25, 2008, the entire contents of which are hereby incorporated by reference herein, for all purposes.

### TECHNICAL FIELD

The present invention relates to virtual community web sites (sometimes called social networking web sites), and more particularly to technology that associates a user's activity in relation to a physical location with a virtual community.

### BACKGROUND ART

It is known in the prior art to provide social networking web sites, which include www.facebook.com, www.myspace.com and www.dodgeball.com. The last web site permits social interaction using a mobile telephone in relation to the web site.

### SUMMARY OF THE INVENTION

In an embodiment of the invention there is provided a computer-implemented method of associating a user's activity in relation to a physical location with a virtual community. The method of this embodiment includes receiving from a personal communication device of the user a message by which is indicated the user's participation in the activity at the location; dynamically updating a location profile associated with the physical location to reflect information inherent in the message; and retrieving data in such updated profile and making the retrieved data available to an audience over the Internet.

In a further related embodiment, the message is formatted in accordance with a protocol for identifying the location and the activity; additionally the method includes using a computer to extract from the message, in a manner dictated by the protocol, the location and the activity. Alternatively or in addition, making data in such updated profile available includes making at least a portion of such profile available via a virtual community web site. Also alternatively or in addition, the activity may include presence of the user at the location and dynamically updating the location profile includes identifying presence of the user. Alternatively or in addition, the method further includes making available, via messaging to a personal communication device of another user who has provided a message by which is indicated participation of such other user in the activity at the location, data identifying the user whose message indicated the user's participation in the activity at the location.

Alternatively or in addition, the method further includes providing a facility permitting the user to post a message, via the user's personal communication device, to other users, each of who has provided a message by which is indicated participation of such other user in the activity at the location. Alternatively or in addition, the method further includes making available, via messaging to the personal communication device of the user, identities of other users, each of who has provided a message by which is indicated participation of such other user in the activity at the location; and providing a facility permitting the user to post a message, via the user's personal communication device, to an identified other user who has been selected by the user.

Alternatively or in addition, the method further includes making available, via messaging to the personal communication device of the user, identities of other users, each of who has provided a message by which is indicated participation of such other user in the activity at the location; and providing a facility permitting the user to post a message, via the user's personal communication device, to each identified other user who has been selected by the user. Alternatively or in addition, the method further includes providing a facility for at least one networked interactive device at the physical location, the at least one networked interactive device being capable of being controlled or accessed by the personal communication device of the user; and providing status information of the at least one networked interactive device to the audience over the Internet. The at least one networked interactive device may include a jukebox, and it may include a big-screen display visible to individuals present at the location. The at least one networked interactive device may include a plurality of networked interactive devices.

In another embodiment of the invention there is provided a system for associating a user's activity in relation to a physical location with a virtual community. The system may include a first data interface, a second data interface, a server and data storage. The first data interface is configured to receive a message originated by a personal communication device of the user. Receipt of the message may indicate the user's participation in the activity at the location. The storage is configured to store a location profile associated with the physical location. The server is coupled to the first data interface, to the second data interface and to the data storage. The server is configured, such that, in response to receipt of the message, the server updates the location profile associated with the physical location to reflect information inherent in the message. The server is also configured to make data in such updated location profile available to an audience over the Internet.

The second data interface may include a web server, an interface to a social networking system, an interface to a virtual community web site, or an interface to a wireless communication network that includes a plurality of wireless personal communication devices, such as mobile telephones.

The message may be formatted in accordance with a protocol for identifying the location and the activity. The server may be further configured such that, in response to receipt of the message, the server extracts from the message, in a manner dictated by the protocol, the location and the activity.

The activity may include presence of the user at the location. The server may be configured, in response to receipt of the message, to update the location profile by identifying the presence of the user.

The server may be configured to make available, via messaging to a personal communication device of another user who has provided a message by which is indicated participation of such other user in the activity at the location, data identifying the user whose message indicated the user's participation in the activity at the location.

The first data interface may be configured to receive a message originated by a personal communication device of the user. The message may include text. The first data interface may be configured to receive messages originated by personal communication devices of other users. Receipt of the messages may indicate the respective other users' participations in the activity at the location. The server may be configured to send messages containing copies of the text to the personal communication devices of the respective other users.

The server may be configured to make available, via messaging to the personal communication device of the user, identities of other users, each of who has provided a message by which is indicated participation of such other user in the activity at the location. The first data interface may be configured to receive a message originated by a personal communication device of the user, wherein the message includes text. The server may be configured to send a message containing a copy of the text to the personal communication device of an identified other user who has been selected by the user.

The server may be configured to make available, via messaging to the personal communication device of the user, identities of other users, each of who has provided a message by which is indicated participation of such other user in the activity at the location. The first data interface may be configured to receive a message originated by a personal communication device of the user, wherein the message comprises text. The server may be configured to send a message containing a copy of the text to the personal communication device of each identified other user who has been selected by the user.

The system may include a third data interface configured to receive communications from at least one networked interactive device at the physical location. The at least one networked interactive device may be capable of being controlled or accessed by the personal communication device of the user. The server may be configured to provide status information about the at least one networked interactive device to the audience over the Internet.

The at least one networked interactive device may include a jukebox or a display screen visible to individuals present at the location or a plurality of networked interactive devices.

In another embodiment of the invention there is provided a method for providing interactive displays. Web pages are made available, from an IP address (such as from a web server), for serving over a first network (such as the Internet) to a plurality of network addressable screens. Each screen is addressable via the first network, and the web pages are served so as to provide contents that are particularized to each of the screens. The web pages are also made available for serving over the first network to other computers coupled to the first network and in communication with the IP address. Commands received over a second network (such as over a wireless telephone network) from user communication devices (such as mobile telephones) are translated. The translated commands are used to affect contents on the screens. Each user communication device separately affects contents on a selected one of the screens. For example, each screen may have an associated identifier (a “loca”), and the loca may be used in sending a given message, to identify which screen the message is to affect. The contents from a selected plurality of the screens may be aggregated, and the aggregated contents may be provided to a selected one or more of the screens.

Optionally, in association with a portion of the aggregated contents, information about a user from whose user communication device was received the command that affected the portion of the aggregated contents may be provided. The information about the user may include: a location associated with the user; a location associated at least a portion of a telephone number (such as an area code) of the user communication device; a location associated the selected one of the screens affected by the user's user communication device; a code (such as a loca) used by the user communication device to identify the selected one of the screens; or an identification of a service (such as Facebook or Twitter), via which the commands were carried.

The contents may be aggregated by selecting contents to aggregate based on the selected one or more of the screens, or such that which contents are made available to which screens depends on information about the location of the screen to which the contents are to be made available, or such that which contents are made available to which screens depends on information about the location of the screen from which the contents are aggregated.

In another embodiment of the invention there is provided a computer-implemented method of associating a user's activity in relation to a physical location with a virtual community. The method includes receiving a plurality of messages. Each message may be from a respective personal communication device of a respective user. Each message may indicate the respective user's participation in a respective activity in relation to a respective location among a plurality of locations. For each message, a location profile associated with the respective location is dynamically updated to reflect information inherent in the message. For each respective location, data in such updated profile is retrieved and made available to an audience over the Internet, so that users in the plurality of locations have access to a common experience via the Internet.

Optionally, making the retrieved data available to an audience includes causing display of the retrieved data on a display at each of at least one of the respective locations or on a display at each of a plurality of the respective locations.

Each respective activity in relation to the respective location may include interaction of the respective user with a display at the respective location.

In yet another embodiment of the invention there is provided a jukebox that includes a display screen, a music playing subsystem and a network interface and a processor coupled to the display screen, the music playing subsystem and the network interface. The processor is programmed to receive, via the network interface, information about first songs selected for play on other jukeboxes. The processor is also programmed to display the information on the display screen.

The processor may be further programmed to receive a user selection of a subset of the information displayed on the screen, as well as to cause the music playing subsystem to play a second song based on the user selection. The information about the first songs may include titles of the first songs. The second song may have a title identical to a first song.

The user selection may include a first song title. The second song has a title identical to the selected first song title.

The processor may be further programmed to receive a user selection of a subset of the information displayed on the screen and display information about at least one third song based on the user selection.

The user selection may include identification of an artist, and the at least one third song may be associated with the identified artist. The user selection may include identification of another user who selected a first song, and the at least one third song may have been selected by the selected another user.

The user selection may include identification of at least one of the other jukeboxes. The at least one third song may have been selected for play on the selected other jukebox.

In yet another embodiment of the invention there is provided a method for operating a jukebox. Information about first songs selected for play on other jukeboxes is received. The information is displayed on a display screen of the jukebox.

Optionally, a user selection of a subset of the information displayed on the screen may be received, and the jukebox may be caused to play a second song based on the user selection.

A user selection of a subset of the information displayed on the screen may be received, and information about at least one third song based on the user selection may be displayed.

### BRIEF DESCRIPTION OF THE DRAWINGS

The foregoing features of the invention will be more readily understood by reference to the following detailed description, taken with reference to the accompanying drawings, in which:

FIG. 1 is a block diagram of a system in accordance with an embodiment of the present invention permitting a user's activity in relation to a physical location to be associated with a virtual community web site;

FIG. 2 is a block diagram of the embodiment of FIG. 1 showing further detail of components associated with the physical location;

FIG. 3 illustrates structural detail, in an embodiment such as that of FIG. 1, of data stored in relation to a location and to a user, as well as the manner in which a web page associated with a user of the virtual community web site is also associated with a physical location;

FIG. 4 illustrates logical flow associated with an embodiment, such as that of FIG. 1, by which a person using a personal communication device and carrying on an activity in relation to a physical location may use messaging to log in to the physical location's proxy so as to interact with components of the virtual community web site to associate the activity with the virtual community;

FIG. 5 illustrates messaging exchanges that may be hosted by an embodiment of the present invention among users, associated through the virtual community web site, who have logged in to the physical location's proxy in the manner of FIG. 4;

FIG. 6 illustrates logical flow in connection with an embodiment of the present invention by which a user, having logged in to the physical location's proxy in the manner of FIG. 4, can post a message to the activity at the physical location;

FIG. 7 illustrates logical flow in connection with an embodiment of the present invention by which a user, having logged onto the physical location's proxy in the manner of FIG. 4, can determine who else is presently logged in to the location's proxy;

FIG. 8 illustrates other functionality (namely, HELP, COMMANDS, and JOIN), in connection with an embodiment of the present invention, that may be invoked by a person using a personal communication device who, in the manner of FIG. 4, has logged in to the physical location's proxy;

FIG. 9 illustrates further functionality (such as contests or sweepstakes, and FORTUNE) in connection with an embodiment of the present invention, that may be invoked by a person using a personal communication device who, in the manner of FIG. 4, has logged in to the physical location's proxy;

FIG. 10 is a block diagram illustrating architecture of an embodiment of the present invention in relation to communication infrastructure that includes virtual community web sites (here called social networks) and various communication devices and services;

FIG. 11 is a replica of a web page of an individual from a virtual community web site, here represented as that of Facebook, showing how, in accordance with an embodiment of the present invention, there may be associated with the web site a user's activity in relation to a number of physical locations;

FIG. 12 is a replica of a web page, linked to the web page of FIG. 11, by which, in accordance with an embodiment of the present invention, among other things, activities at the physical locations can be indicated to the user;

FIG. 13 is a replica of a web page, in accordance with an embodiment of the present invention, showing the result of a search for web pages for proxies of physical locations near a given city;

FIG. 14 is a replica of a web page, in accordance with an embodiment of the present invention, for a proxy of a particular physical location;

FIG. 15 shows hypothetical contents that may be displayed on a screen by an embodiment that implements a message board application, according to one embodiment of the present invention;

FIG. 16 shows a hypothetical touch-sensitive display screen on a jukebox, according to one embodiment of the present invention;

FIG. 17 is a block diagram of a screen network, according to one embodiment of the present invention; and

FIG. 18 is a block diagram of a jukebox, according to one embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

To “update” content includes revising previously stored data that is relevant to such content, as well as storing data relevant to such content in the first instance.

Information “inherent” in a message includes information explicitly included in the message (including in the header, body or other portion of the message or associated signaling, overhead, channel or other packets, data structures or the like), as well as information derivable from the format of the message.

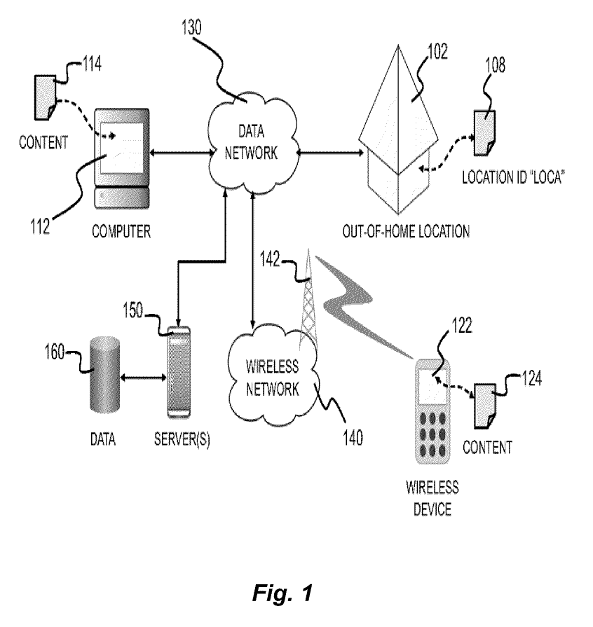

FIG. 1 is a block diagram of a system in accordance with an embodiment of the present invention permitting a user's activity in relation to a physical location to be associated with a virtual community web site and, therefore, with a virtual community created by the web site. Typically a user may use a computer 112 to access, over a data network 130 (which may be the Internet), content 114 in a virtual community web site, established by server(s) 150 coupled to data storage 160. In addition, a user may have a personal communication device (such as a mobile telephone or other wireless device) 122 to engage in data communication, first over a wireless network 140 and then via the data network 130 to access content 124.

The embodiment of FIG. 1 conceptually integrates these facilities with one or more physical locations. In FIG. 1, a representative physical location is shown as out-of-home location 102. In this embodiment, we associate a dynamic collection of data with the location 102, and to access the dynamic collection of data for the location 102, we apply a logical identifier that we call a “loca,” which is unique (at least within the system or within a group of locations represented by data in the system) for the specific location. In other words each physical location integrated into the system has a unique logical identifier, that is, a unique loca. The ultimate repository of the data associated with the location 102 may be the data storage 160. In the present embodiment, the user may therefore employ the personal communication device 122 to access information about the location 102 itself, and, as we shall see, to communicate with others who have indicated their physical presence at, or interest in, the location 102.

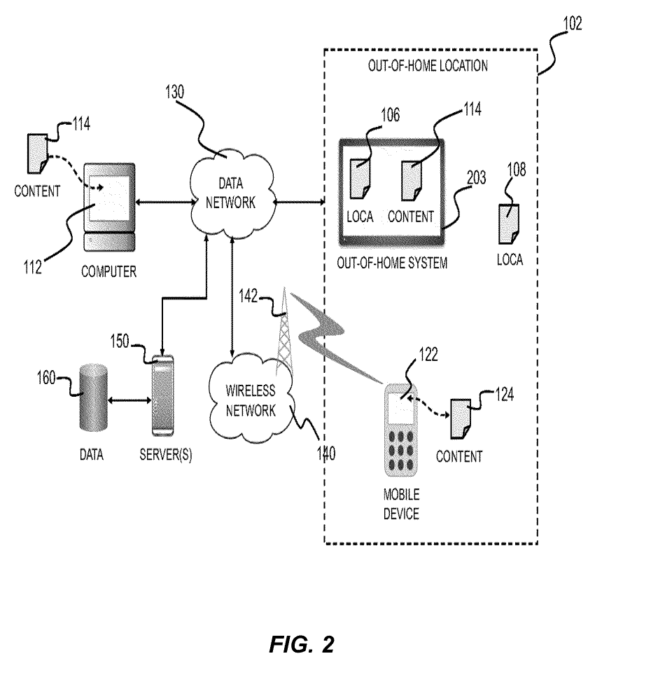

FIG. 2 is a block diagram of the embodiment of FIG. 1 showing further detail of components associated with the physical location. The dynamic collection of data associated with physical location 102 we call a “proxy” (represented as the out-of-home system 203 of FIG. 2) for the physical location 102, and the proxy is established in the virtual world, namely on the virtual community web site. The proxy 203 includes dynamic content 114 pertinent to the location 102, as well as a suite of loca-based data 106 relating to the location. This data is communicated over the data network 130 and is stored in data storage 160.

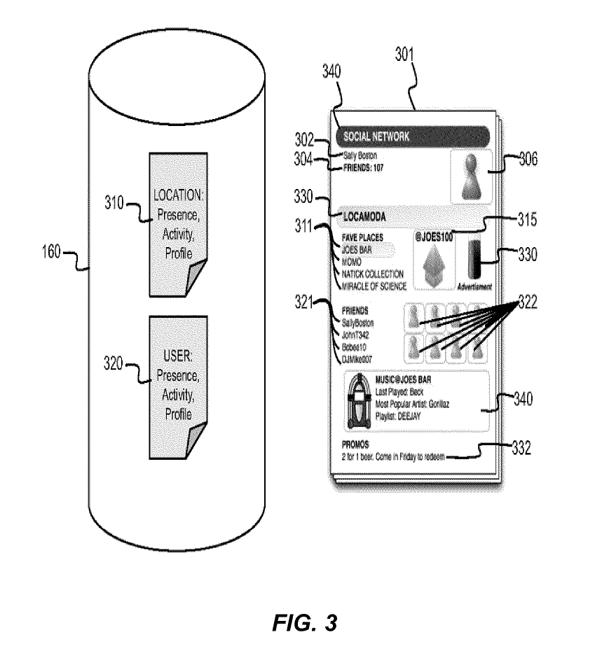

FIG. 3 illustrates structural detail, in an embodiment such as that of FIG. 1, of data stored in data storage 160 of FIG. 1 in relation to a location and to a user, as well as the manner in which a web page associated with a user of the virtual community web site is also associated with a physical location. Beginning on the left side of FIG. 3, we see content of data storage 160. In this embodiment, for each location having a proxy in the embodiment of FIG. 1, there is stored information 310 that identifies: (i) the presence in the physical location 102 of any users who have made themselves known in relation to the location 102, typically via their personal communication devices, (ii) any activities under way with respect to the location 102, and (iii) a profile of the location 102. This profile may include commercial offerings available at or from the location 102, its address and other contact information, and other details concerning the location that may be of interest to the virtual community, or to potential members of the virtual community. In a complementary manner, there is stored for each user of the system, information 320 that identifies: (i) any presence of the user at the location, (ii) any activities of the user at the location, and (iii) a profile of the user.

Turning now to the right side of FIG. 3, we see a representative web page 301 associated both with a user of the virtual community web site and also associated with a physical location; this web page relies on data stored in data storage 160. The virtual community web page 301 identifies the name of the virtual community with banner 340, and includes a photograph, icon or avatar 306 of the user, and provides user name 302 and a hyperlink 304 to user-designated “Friends” of the user who are also members of the virtual community. Under the “LocaModa” banner 330 is provided a listing of hyperlinks 311 to proxies for locations that the user has identified as favorites (“Fave Places”) and that are represented in data storage 160. Here “Joe's Bar” has been highlighted, and accordingly information concerning this location is provided. Immediately to the right of the listing of hyperlinks 311 is a picture or icon representing Joe's Bar, as well as text specifying the “loca” (logical identifier) for that location used in sending messages from a user's personal communication device relating to the location. Next, presence information is provided listing those individuals 321 who are “Friends” of the user who have additionally made themselves known in relation to the location's proxy via messaging on their personal communication devices. These individuals 321 may, but need not, be physically present at the location. Photographs 322 of the individuals 321 are also provided. A region 340 of the web page is devoted to activities at the location, and here displayed is activity, such as of the jukebox, at Joe's Bar. The juke box is shown to be accessed by a user using the user's personal communication device by sending a message to “music@joesbar.” The region 340 also displays the music currently being played or last played, the most popular artist and the playlist identifier. The region 340 may also display an identification (not shown) of the user who requested the current or most recently played song. Region 345 of the web page includes advertising content, and this content may be customized, if desired, based on profile data for the location whose hyperlink has been invoked. For example, the advertisement may relate to bars in other cities, other hot spots in the vicinity of the location, etc. Customization can also be based on the user profile data. Region 332 includes promotion information specific to the location, and here the offer is “2 for 1 beer.”

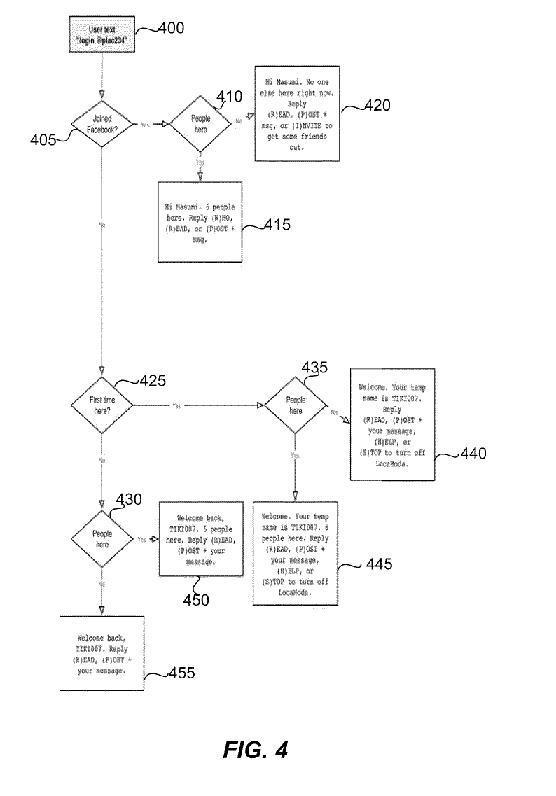

FIG. 4 illustrates logical flow associated with an embodiment, such as that of FIG. 1, by which a person using a personal communication device and carrying on an activity in relation to a physical location may use messaging to log in to the physical location's proxy so as to interact with components of the virtual community web site to associate the activity with the virtual community. (By way of background, it is possible for a user equipped with a personal communication device to interact at the location when the location is equipped with a large display in a manner described in our International Application PCT/US2005/040186, published May 18, 2006 as WO2006/052837 and entitled “A System and Method for Interactive Marketing;” and our published U.S. patent application Publication No. US 2007/0294096, published Dec. 20, 2007, filed Apr. 30, 2007 and entitled “A System and Method for Interactive Marketing,” these applications are hereby incorporated herein by reference in their entirety, and are referred to below as “our PCT and US Applications.” Additional information is available in our U.S. Provisional Patent Application No. 61/095,313, filed Sep. 9, 2008 and entitled “Automatic Content Retrieval Based on Location-Based Screen Tags,” and our issued U.S. Pat. No. 7,450,954, issued Nov. 11, 2008 and entitled “System and Method for Location-based Interactive Content, the entire contents of all of which are hereby incorporated by reference herein.) In this figure, and in FIGS. 4-9 generally, we assume that the user is using a mobile telephone to send text messages. However, it will be appreciated that other personal communication devices may be used, and that the messaging may also include data other than text, including multimedia data.

As shown at 400, to log in to the location, the user sends a text message using the e-mail, SMS or other address (i.e., the loca or the logical identifier) for the location. FIG. 4 shows the loca as “@plac234.” In an embodiment, to the left of the “@” symbol is placed the relevant function or activity that relates to the location. Because in the case of FIG. 4 the function is logging in, the left side of the e-mail address for the text message is “login.” The complete address is therefore login@plac234.

When the user sends this text message, the user is identified to the system by the user's phone number, and the loca is used by the system for properly associating the user with the appropriate location proxy. The system uses the user's phone number to determine, at 405, whether the user has already joined the virtual community (in this example, Facebook). If so, there is further branching at 410 depending on whether other users have logged in to the location proxy. If so, then there is a responsive message back to the user identifying the number of “people here,” as shown at 415.

The responsive messages include codes at the ends to simplify user interaction with the system. In this case, the use can ask (W)HO, (R)EAD, or (P)OST. The user may abbreviate a command to the first letter of the command, as indicated by the parentheses. The POST command applies to a message that the user would send with the command. Note that once the user is logged in, further system interaction is handled merely by processing message replies of the user.

If other users have not logged in to the system, then the user is so informed at 420 and given the options of (R)EAD, (P)OST+message, OR (I)NVITE. If, in FIG. 4, the user has not jointed Facebook, then there is further branching at 425 according to whether it is the user's first time at the location (if so, a temporary name is assigned to the user) and at 430 and 435 according to whether there are others who have logged in to the location's proxy. At 440, 445, 450 or 455, an appropriate welcome message displays the user's temporary name, the number of other users logged in to the location proxy (if any) and a list of legal commands, each as (R)EAD and (P)OST.

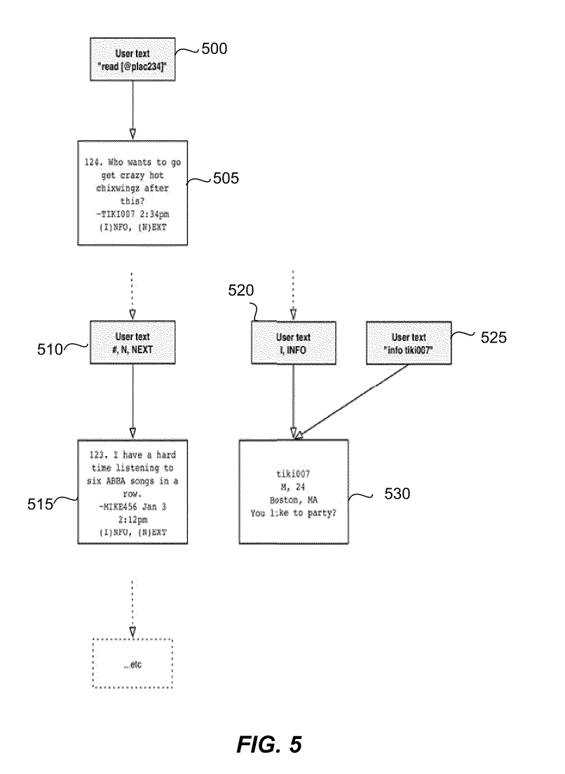

FIG. 5 illustrates messaging exchanges that may be hosted by an embodiment of the present invention among users, associated through the virtual community web site, who have logged in to the physical location's proxy in the manner of FIG. 4. In FIG. 5, the user, who has already logged in to a location having the loca @place234 as illustrated in FIG. 4, has sent the reply message “READ” at 500, and is presented (at 505) with a message, having a posting number 124, from a user having an identification TIKI007. The message, as usual, gives the user a number of commands that the user can enter in reply, including (N)EXT. In one scenario, beginning at 510, the user sends a command (which can be by specifying the message number, by typing N, or by typing NEXT, in the reply message) asking for the next message, and at 515 the system replies with message 123 and a number of commands that the user can enter in reply. Alternatively, following the message number 124, as illustrated in the example beginning at 520, the user may reply with I or INFO in the message or (at 525) with “Info tiki007,” and get a system reply 530 with data about tiki007.

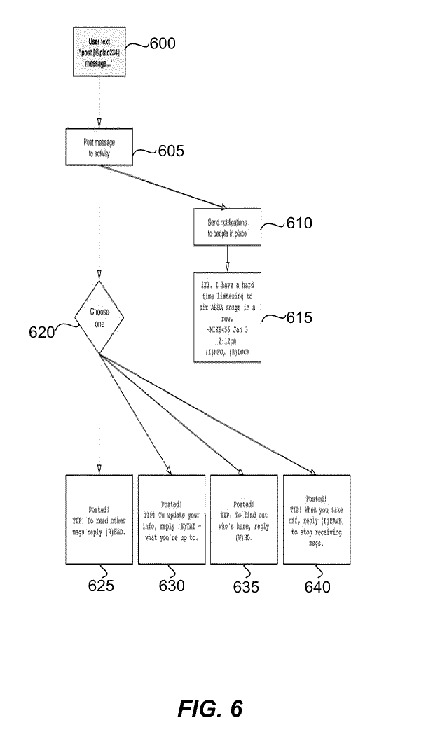

FIG. 6 illustrates logical flow in connection with an embodiment of the present invention by which a user, having logged in to the physical location's proxy in the manner of FIG. 4, to post a message to an activity at the physical location. As shown at 600, the user sends in the reply message the command “post” with the message to be posted. At 605, the system responds by posting the message to the activity associated with the location's proxy. Posting the message may include displaying the message on a display screen at the location, optionally along with attribution information, such as the user's user name, location, icon, avatar, communication mode (ex. mobile device, web, etc.), and the like. For example, if the activity relates to a jukebox, the message may be displayed on a screen of the jukebox. If the activity involves a “Wiffiti” message posting board or a word game, the screen may be a large screen that maybe viewed by patrons of the location or a large screen visible from a public place, such as Time Square in New York City. Then, at 610, the system sends notifications (exemplified at 615) to those users who have logged in to the proxy for the location. The system may notify user who have logged in to the proxy that a new message has been posted. The notifications may include a copy of all or a portion of the posted message. At 620, the system selects one of four messages 625, 630, 635 or 640 to send to the user, each message informing the user of the posting and offering a specific tip to the user for use of the system.

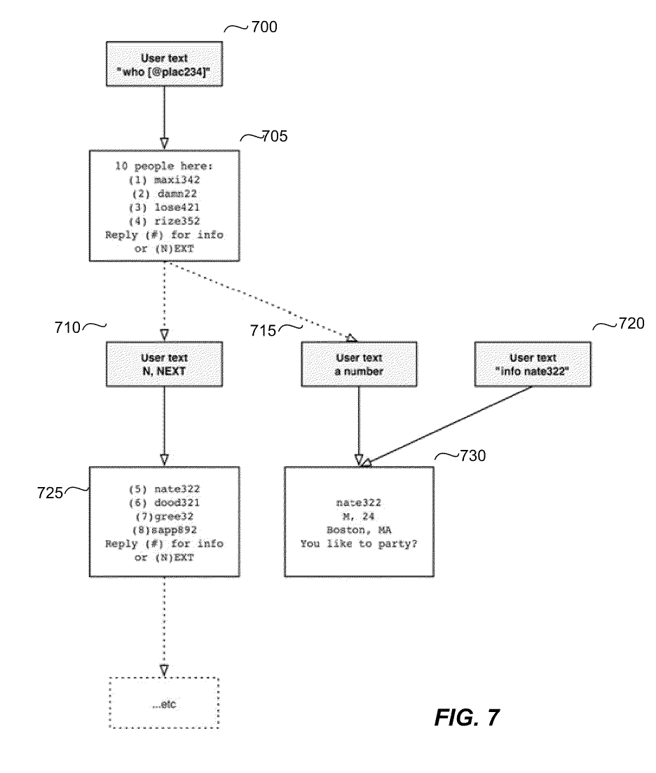

FIG. 7 illustrates logical flow in connection with an embodiment of the present invention by which a user, having logged in to the physical location's proxy in the manner of FIG. 4, to determine who else is presently logged in to the location's proxy. At 700, the user in a reply message types “who,” and the system responds at 705 with a message indicating that ten people have logged in to the physical location's proxy, lists the first four people, and provides instructions to “Reply (#) for info or (N)EXT.” Three different scenarios (beginning at 710, 715 and 720, respectively) are indicated. When the user replies with N or NEXT at 710, the result is a listing 725 of the next four of the ten people, and similar instructions to “Reply (#) for info or (N)EXT.” Alternatively a user may send a reply with the message giving the number of the person on the list (715) or the reply message “info nate322” (720), where “nate322” is the user name of the person for which information is sought; in either case, information about this person is returned by the system in a message at 730.

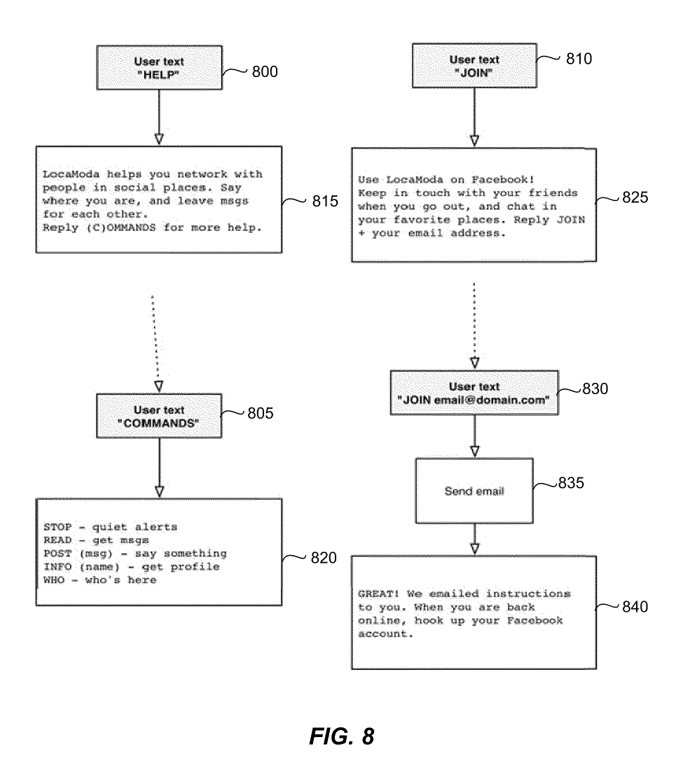

FIG. 8 illustrates other functionality (namely, HELP 800, COMMANDS 805, and JOIN 810), in connection with an embodiment of the present invention, that may be invoked by a person using a personal communication device who, in the manner of FIG. 4, has logged in to the physical location's proxy. In each case the text message 800, 805 or 810 is followed by the system response 815, 820 or 825, respectively. If the user sends a message of the form “JOIN email@domain,” as shown at 830, the system sends an e-mail message 835 containing instructions to the specific e-mail address and a message 840 directly to the user.

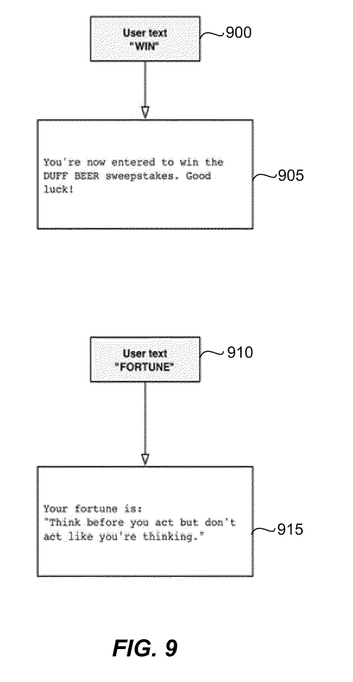

FIG. 9 illustrates further functionality (such as contests or sweepstakes, and FORTUNE) in connection with an embodiment of the present invention, which may be invoked by a person using a personal communication device who, in the manner of FIG. 4, has logged in to the physical location's proxy. As shown starting at 900, when the user replies to a message with the text “WIN,” the system responds at 905 that the user has entered into a sweepstakes associated with the location. As shown starting at 910, when the user replies to a message with the text “FORTUNE,” the system responds at 915 with a message providing the user with a fortune prediction. Other functionality may be similarly provided. For example, a user may obtain local weather, interior or exterior temperature, sound level or other information about the location by sending appropriate messages, such as “WEATHER,” “TEMPINSIDE,” “TEMPOUTSIDE” or “SOUND.”

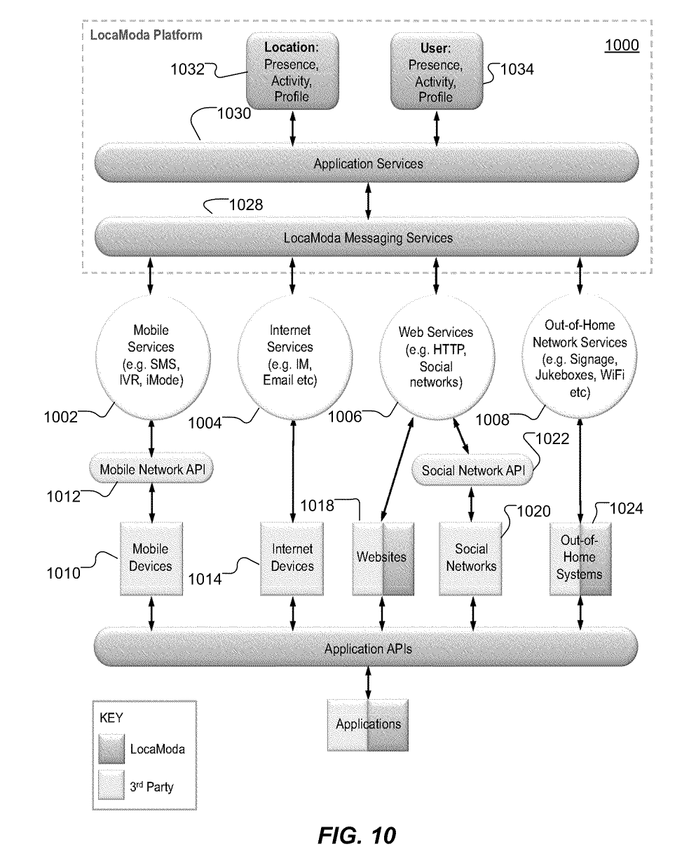

FIG. 10 is a block diagram illustrating architecture of an embodiment of the present invention in relation to communication infrastructure that includes virtual community web sites (here called social networks) and various communication devices and services. The architecture includes a platform 1000 connected to one or more services, exemplified by a mobile service 1002 (such as a short message service (SMS), interactive voice response (IVR), iMode, etc.); an Internet service 1004 (such as instant messaging (IM), e-mail, etc.); a web service 1006 (such as HTTP, social networks, etc.); and an out-of-home network service 1008 (such as signage, jukeboxes, WiFi, etc., discussed in more detail below). A variety of devices and networks may communicate with associated services via appropriate interfaces, as needed. For example, mobile devices 1010 communicate via a mobile network API 1012 with the mobile services 1002. The mobile devices 1010 may, for example, send text messages (such as SMS messages) through the mobile services 1002 to the platform 1000. Internet devices 1014, such as PCs or Internet-connected mobile telephones, may send messages via the Internet services 1004 to the platform 1000. Web sites 1018 and social networks 1020 (such as Facebook) may communicate (via APIs 1022, if necessary) with the platform 1000. Out-of-home systems 1024, such as displays disposed at physical locations, may communicate via the out-of-home network services 1008 with the platform 1000. The platform 1000 may cause contents to be displayed on the out-of-home systems 1024, and users may interact with the out-of-home system 1024, such as by sending messages from their mobile devices 1010 or PCs 1014, as described in our PCT and US Applications referenced above.

In addition to the types of user interactions with screens discussed in our PCT and US Applications and the other incorporated documents, contents sent to each of a plurality of screens by various users, or contents otherwise caused to be displayed on the plurality of screens by the users, may be aggregated, and the aggregated contents may be displayed on any subset or all of the screens. In one embodiment, each user causes contents to be displayed on a particular screen by addressing that screen using the screen's identifier (loca), as described elsewhere. For example, the user may be a participant in a Wiffiti message board or a word game and thus send words or letters to be displayed on a screen located in an establishment, such as an ice cream parlor, where the user is present, or with which the user has associated himself or herself by logging in to the location's proxy. Other users or groups of users may be similarly interacting with other screens at other locations, each hosting a separate activity. However, there may be an insufficient number of users in, or associated with, each location to support a lively game in that location.

To solve this problem, the system may aggregate the contents of several screens, each located at a different location, such as different ice cream parlors, a mixture of venue types (such as ice cream parlors and cafés) or different portions of a large establishment (such as different rooms of a casino). Aggregation here means summing the contents originally directed to several screens. The system may display the aggregated contents on all or a subset of the screens in the various locations. Consequently, interactions (such as words or letters) of a larger number of users may be displayed on a given screen, or on each screen, than were directed to that screen. The larger number of interactions may provide sufficient activity to support a lively game.

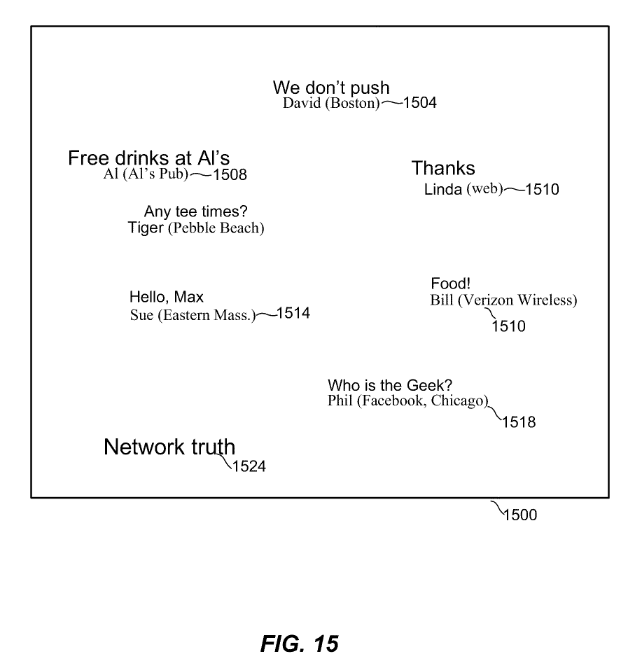

Contents displayed on a screen as a result of a user's interaction may be tagged with various types of information relating to the user. For example, to identify the user, such tagging may include information about the screen to which the user directed the interaction, the location in which the screen is located, more general information about the location of the user or a location with which the user is associated, the service and/or the interface device used by the user, the number of participants at the user's location, or other location or profile information. FIG. 15 shows hypothetical contents that may be displayed by an embodiment that implements a Wiffiti message board application. A display screen 1500 displays text messages posted by various users in a manner, as described. That is, each message is posted to a particular screen, identified by a loca.

For the sake of this example, the screens may be located in various ice cream parlors, cafés and nightclubs. The administrator of each screen may choose whether only messages posted to the screen are displayed, or aggregated messages posted to several screens are displayed.

Groups of screens may be considered to form a network. For example, screens that are located in franchise locations of a particular ice cream parlor chain may be considered to be members of one network, and screens that are located in franchise locations of a particular chain of nightclubs may be considered to be members of a different network. The administrator of a screen may, for example, select to display messages posted to the screen, as well as messages posted to other screens in the same network, but not messages posted to a rival chain's screen network. Alternatively, the administrator may select to display messages posted to rival chains' networks, providing the posted to screen is located at least 50 miles away. Optionally, the administrator may select to display messages posted to other screens and other networks, but without attribution or with limited attribution, i.e., without the name of the poster or with the name of the poster but without the poster's location. Other types of screen or network selection criteria and/or attribution limits may be used.

Examples of message postings and attributions are shown in FIG. 15. For example, at 1504, a message posted by user “David” is shown, indicating that the user is located in Boston. This location information may be ascertained from the location of the screen to which the user posted the message (i.e., from the loca the user used to post the message), the area code of the user's communication device, profile information about the user stored in the system's data store 160 (FIGS. 1 and 2), profile information stored by the user's social network or by any other suitable method or system. Another message posting 1508 is attributed to “Al” and shows the identity of the screen (“Al's Pub”), to which the message was posted. The screen identity may be the loca (ex. “@RedBones”) used to address the screen or the screen identity may be a full name (ex. “Al's Pub”) of the screen's location, according to the location's profile stored in data storage 160 (FIGS. 1 and 2).

Sometimes, it may not be possible to ascertain the user's location, or it may be possible to ascertain only a general location of the user. Messages from users who access the system via a web page may be so attributed, as shown in message posting 1510. The area code of a user may provide only general location information, such as “Eastern Massachusetts,” as shown in message posting 1514. If a message is posted through a social network or other identified system (such as Facebook or Twitter), the network or system may be identified, as shown in message postings 1518 and 1520. Profile information from the social network may include the user's location, as provided by the user to the social network.

In addition, a user may use a generic loca for sending messages to the system, rather than using a loca of a particular screen. For example, the user may send messages to a generic SMS short code. The system may select one or more screens, on which to display the user's message or otherwise interact with the screen based on the user's profile, area code, location information provided by a wireless communication network or other selection criteria. The system may look up the user's telephone number in the system's user profile information (such as in data storage 160), and use location information in the user's profile to ascertain or presume the user's location.

As noted, the administrator of a screen or a screen network may chose not to attribute some or all message postings. A message posting without attribution is shown at 1524.

Returning to FIG. 10, the platform 1000 includes appropriate messaging services 1028, by which the platform 1000 communicates with the services 1002-1008. The platform 1000 also includes application services 1030. The platform 1000 also includes location services 1032 and user services 1034. The location services 1032 accept, store and provide information about physical locations and their corresponding proxies. This information may include presence information, i.e., information about individuals who are present at the physical locations or logged in to the locations or their proxies. Users log in and out by sending messages to the proxies, and the system may update the users' personal information as a result of receiving these log-in and log-out messages. Also included is information about activities taking place or scheduled to take place at the physical locations, and profile information about the physical location and its proxy, such as street address, telephone number, short code (to which messages are sent), links to fans and the like. The system may be connected to sensors, such as sound, light, temperature, wind velocity sensors or cameras positioned in or near the location to provide corresponding data about the location.

The user information 1034 contains presence information, such as the location(s) to which a user is logged in, a physical location where the user is physically present, and the like. The user information 1034 also includes activity information, such as activities the user is interested in or is participating in. Profile information may include name, interests, age and the like.

Further examples of screens or screen networks include screens in elevators (such as those operated by Captive Networks or Elevator News Network), lobbies, store windows, signs and on kiosks (such as kiosks in shopping centers, gasoline pumps and self-checkout cash registers). Many of these screens display contents, such as news, weather and advertising, provided by central systems. All such screens may be considered out-of-home systems 1024 and may be coupled to the platform 1000, as described above. Thus, the platform 1000 may cause contents to be displayed on one or more out-of-home system screens 1024, or at least making contents available to such screens or their respective networks. (It should be noted that it may be illegal to operate a cell phone near a gasoline pump.)

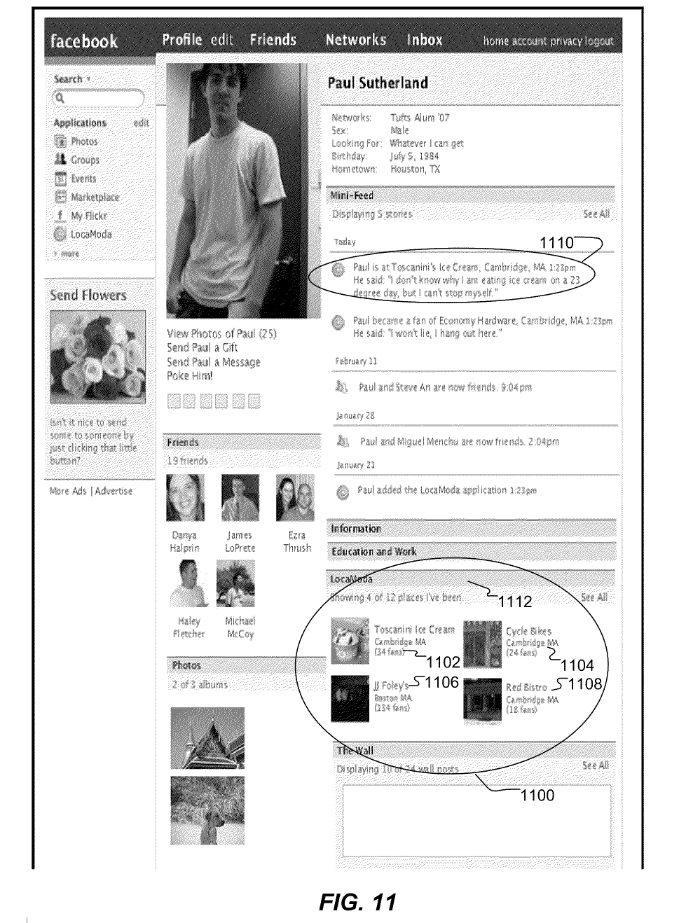

FIG. 11 is a replica of a web page of an individual from a virtual community web site, here represented as that of Facebook, showing how, in accordance with an embodiment of the present invention, there may be associated with the web site a user's activity in relation to a number of physical locations. A portion 1100 of the web page may display a scrollable list of proxies for physical locations that the individual has recently logged in to. For example, the individual identified on the web page has recently logged in to Toscanini Ice Cream 1102, Cycle Bikes 1104, JJ Foley's 1106 and Red Bistro 1108. For each physical location 1102-1108, an icon and information, such as location and number of fans, may be displayed. (“Fans” are individuals who have subscribed to a physical location, without necessarily completing a mutual-approval process. In some virtual communities, fans may subscribe to individuals, films, bands, public figures, businesses, products, etc.) The web page may also display postings made by the individual, as indicated at 1110.

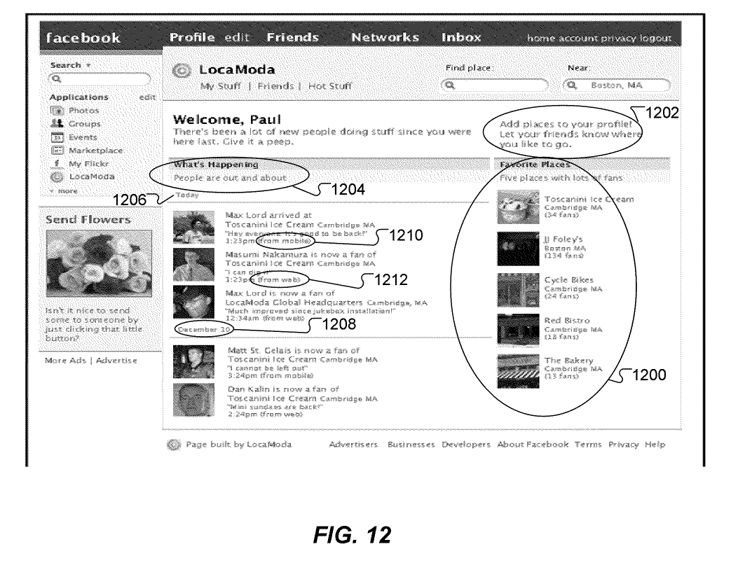

Additional information about a physical location may be accessed by invoking a link 1112 on the web page to cause a subsequent web page, an example of which is shown in FIG. 12, to be displayed. FIG. 12 is a replica of a web page, linked to the web page of FIG. 11, by which, in accordance with an embodiment of the present invention, among other things, activities at the physical locations can be indicated to the user. A list of physical locations that have been identified by the individual as being of interest (“Favorite Places”) may be displayed, as shown at 1200. An icon and information about each location (as described above) may be displayed. The web page may encourage the individual to add physical locations to the individual's profile, as exemplified at 1202, to increase the likelihood of the system identifying an activity or another individual that may be of interest and present in, or associated with, a physical location that is listed in the profile.

The web page may also display a list 1204 of other individuals who are currently, or have recently been, present at, or associated with, physical locations that are of interest (“Favorite Places”). This list may include real-time information and/or information about a near-term time frame, such as “Today” 1206 and/or information about past time frames, as exemplified at 1208. For each individual included in the list, the information may include a photograph, an icon, an avatar or the like, as well as the time the individual arrived at the physical location or logged on to the physical location, a copy of a post made by the individual and its time and an indication of how the post or logon was accomplished, such as via a mobile device 1210 or via the web 1212.

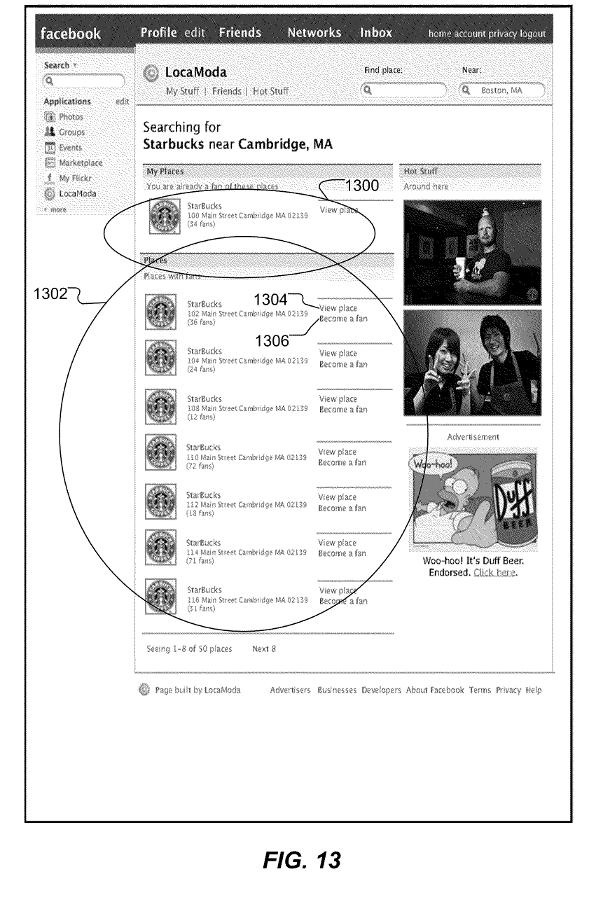

A user may search for physical locations, based on various selection criteria, such as location, type of service or product offered at the location, hours of operation, the presence of other identified individuals present or logged on to the location and the like. FIG. 13 is a replica of a web page, in accordance with an embodiment of the present invention, showing the result of a search for web pages for proxies of physical locations near a given city. If any of the resulting physical locations are listed in the searching individual's Favorite Places, these locations may be listed separately, as indicated at 1300. Other resulting physical locations may be listed simply as “Places” 1302. For each physical location, information, such as address and number of fans, may be displayed. The list may include links to facilitate viewing detailed information about a physical location 1304 and becoming a fan of the physical location 1306.

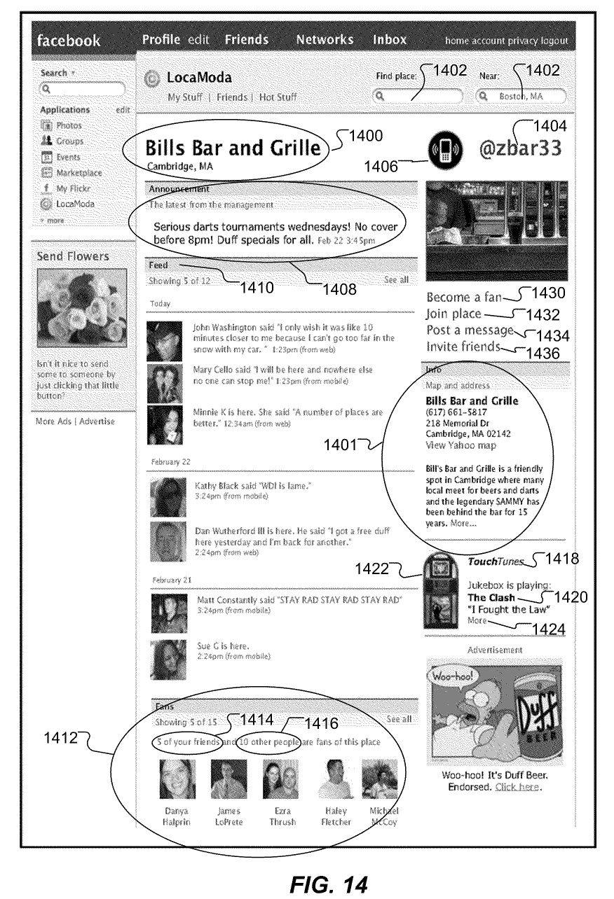

Detailed information about a physical location may be displayed, such as by invoking the link 1304 shown in FIG. 13. FIG. 14 is a replica of a web page, in accordance with an embodiment of the present invention, for a proxy of a particular physical location. The web page may include information about the physical location, such as its name, telephone number and address 1400 and 1401 or an image (not shown) captured by a camera at the location. Search criteria may be entered via one or more fields 1402.

The web page may also display an electronic address (“loca”), exemplified by 1404, by which a user may interact with the proxy. Such interaction may take a variety of forms, including logging in to the proxy, posting messages to the proxy, interacting with activities (such as a jukebox) taking place at the physical location or on its proxy and the like, as discussed above. This electronic address 1404 may be any type of address that may be used to send a message. In the example depicted in FIG. 14, the address is a “short code” SMS (short message service) address, to which a text message may be sent, such as from a mobile telephone or Internet-connected computer. Other types of addresses include telephone numbers and e-mail addresses.

The web page may include an icon 1406 which, when invoked, displays a separate window (not shown) for accepting a message and then sending the message to the address 1404, without requiring a user to manually activate a separate application program or use a separate device, such as a mobile telephone. The separate window may provide the user several options, such as “Log on,” “Log off,” “Post” and the like. Alternatively, activating the icon logs the user on the physical location or toggles the user's current logged-on state at the physical location.

The web page may display messages of general interest, as exemplified at 1408. The web page may also include a link 1430 for becoming a fan of the physical location, a link 1432 for joining the location, a link 1434 for posting a message to the location, and a link 1436 for inviting a friend to visit the location.

The web page may display a list of current and recent postings 1410 to the physical location by individuals. As discussed above, each of the entries in the list may include information about the individual who posted the message, including information about whether the posting was made from a mobile device or from the web. The web page may also display a list of fans 1412 of the physical location. This list may include all such fans, or the list may include fans who also match a selection criterion, such as friends of the individual performing the query. The web page may provide information 1414 and 1416 about the number of fans who fall within each category.

The web page may list activities, services, products, devices, etc. (collectively “activities”) available from or located at the physical location. An example activity, a jukebox, is depicted at 1418. Information about the current state of the activity, such as the current song being played on the jukebox 1420, may be displayed. The activity display may include an icon 1422, by which the user may interact with the activity. For example, invoking the icon 1422 may invoke a web page that enables the user to select a song to be played on the jukebox at the next available time slot or at a user-specified time and/or date in the future and, optionally, arrange for payment for the song, such as by credit card or by accessing an account maintained by the physical location. Other information, such as a list of recently played songs, a list of available songs, a list associating songs with users who have selected the songs, or a request to add or remove a song from the list of available songs, may be displayed in response to invoking another link 1424. Some embodiments stream the currently playing song, so an Internet-connected user may hear the song, as it is being played at the location.

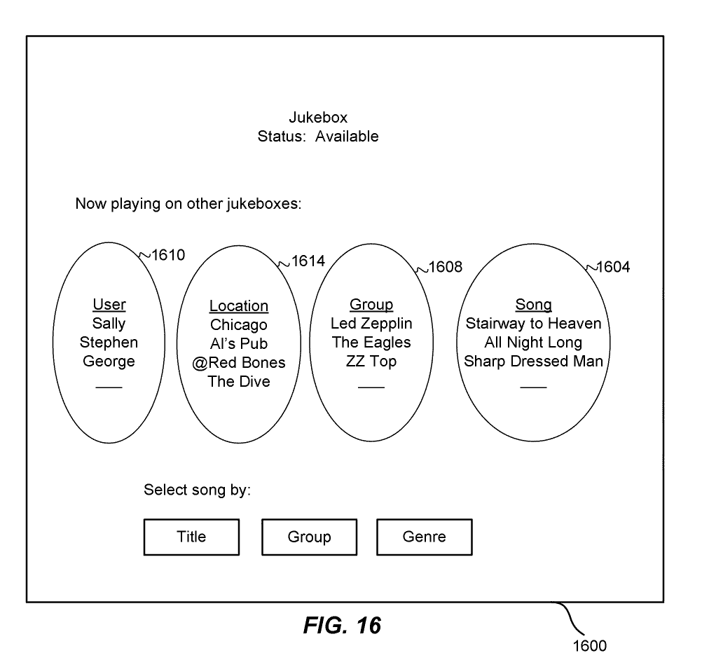

The platform 1000 (FIG. 10) may collect information from various out-of-home systems 1024 and display or otherwise make available this information to users. For example, the platform 1000 may collect play information from jukeboxes in various locations and provide this information to all or selected jukeboxes. FIG. 16 shows a hypothetical touch-sensitive display screen 1600 on a jukebox, according to one embodiment. The display screen 1600 displays information about songs 1604 and groups or artists 1608 playing on other jukeboxes, as well as information about the users 1610 who selected the songs and the locations 1614 of the jukeboxes. Optionally, as shown in the last line of the display, jukeboxes that are not currently playing any song may be identified. The display shown in FIG. 16 may be shown on the jukebox when the jukebox is idle, i.e., while the jukebox is not playing a song. Optionally, the display shown in FIG. 16 may be shown while the jukebox is playing a song, or the display may be shown in response to a user action, such as invoking a “Show information about other jukeboxes” button.

A user may select a song that is currently playing on another jukebox, such as by clicking on the song 1604 to have the jukebox at the user's location play the song. Alternatively, the user may select the group or artist that is currently being played on another jukebox by clicking on the group or artist 1608, and the jukebox displays a list of songs (not shown) by the selected group or artist, and the user may then select a song for playing. Similarly, the user may select the location of another jukebox by clicking on a location 1614, and the jukebox displays other songs and artists recently played by the selected jukebox and the users who selected the songs. Similarly, the user may select another user by clicking on the other user 1610, and the jukebox displays other songs and artists recently selected by the selected other user, as well as other jukeboxes on which the other user has selected songs (not shown). The user may select a song, artist or jukebox so displayed, and the jukebox plays the song, displays other songs by the artist or information about the other jukeboxes, depending on the user's selection.

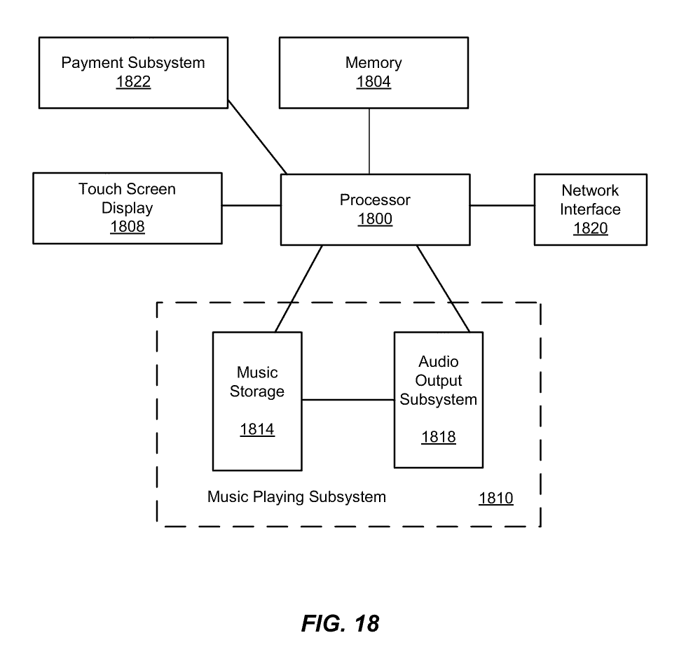

FIG. 18 is a block diagram of a jukebox, according to one embodiment. A processor 1800 executes instructions stored in a memory 1804 to perform various functions, including displaying selection options (such as song titles) on a touchscreen display 1808 and receiving user selections via the touchscreen display 1808. The processor 1800 causes a music playing subsystem 1810 to play a selected song. The music playing subsystem 1810 includes music storage 1814, which may include optical or other suitable storage on which digitized songs are stored, and an audio output subsystem 1818 capable of producing sound from the stored songs. The processor is also coupled to a network interface 1820, through which the jukebox may be coupled to the LocaModa platform. Optionally, a payment subsystem 1822 accepts payment, such as by currency, credit card, debit card, account number or the like, and may issue change or refund, based on costs of the songs selected by the user and played by the jukebox.

Displaying information about songs, artists and users of other jukeboxes may encourage a user to select a song being played on another jukebox, or a different song by the same artist, in order to gain something in common with other users and, possibly, establish a basis for interactions (such as messaging, as described above) with the other users. Seeing that favorite songs or artists are played on another jukebox may create a feeling of affinity between the user and the location in which the other jukebox is located.

Jukebox information, as discussed with respect to FIG. 16, may instead or in addition be shown on a large screen display in the location and/or other locations, and user may interact with this/these screens, as discussed above. Similarly, a jukebox screen may be used as an out-of-home display screen for general interaction, such as for showing Wiffiti messages, games, and the like, as discussed above, and users may use mobile communication devices to interact with the screen contents.

Information about activities, and/or users who are participating in the activities, may be used to select advertising to be displayed on screens located where the activities are taking place. For example, information about the type of music being played at a location (i.e., musical style, genre, artist, etc.) may be used to select advertising to display on the screen(s) of associated jukebox(es) and/or display screen(s) co-located with the jukebox(es), or advertising to be sent to mobile devices or computers of users who have logged in to proxies of the locations. Similarly, information about users who are physically present at, or logged in to proxies of, locations, or users who have selected songs on jukeboxes, may be used to select the advertising.

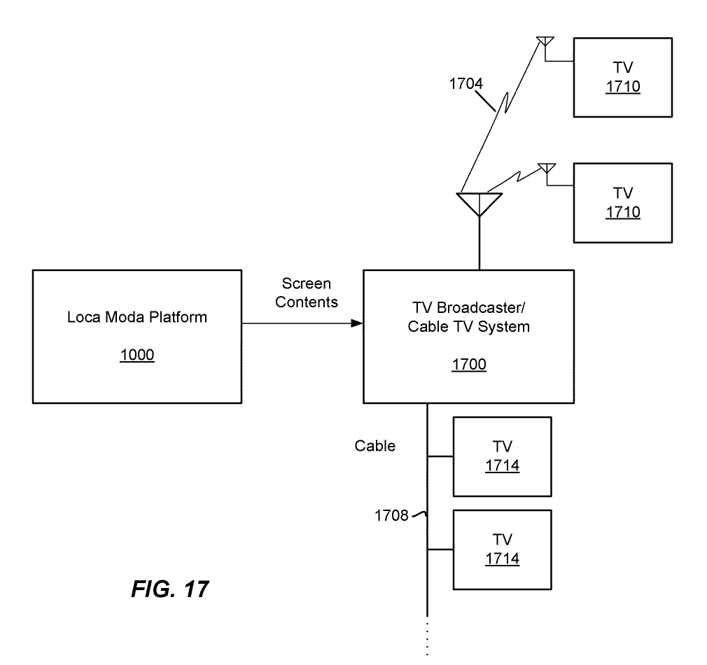

Various networks of screens, such as screens in ice cream parlors or screens on kiosks, have been described. Other types of screen networks may be created by television broadcasters or cable TV systems, as shown in FIG. 17. The LocaModa platform 1000 generates screen contents, as described above and provides the screen contents to a TV broadcaster or cable TV system 1700. The TV system generates a video signal from the screen contents and broadcasts the video signal as an over-the-air signal 1704 or over a cable 1708. Televisions 1710 and/or 1714 tuned to the over-the-air signal 1704 or the signal provided over the cable 1708 display the screen contents. Users may interact with the screen contents using their mobile communication devices or Internet-connected computers, as discussed above, thus creating an interactive channel from a non-interactive TV channel. In such cases, the back channel, i.e., the channel over which user inputs are carried, is typically different than the forward channel, over which the screen contents are carried. Digital TV channels may include one or more sub-channels, some of which may utilize less bandwidth than others. For example, a digital TV channel may carry a high-definition TV (HDTV) sub-channel, as well as standard definition TV sub-channels and data sub-channels. The screen contents from the LocaModa platform 1000 may be carried by a low bandwidth standard definition TV sub-channel or by a data channel. In the latter case, the TV 1710 or 1714 or a set-top-box may be required to convert the data signal into a screen image.

Other examples of activities include special events, such as a sales promotion for a particular brand of beer, karaoke night or entertainment of a particular type (movie, band, comedian, open microphone night, etc.) or by a particular entertainer. Invoking the icon for an activity may enable a user to sign up to participate in or observe the associated activity, including possibly reserving a seat or table.

A system for associating a user's activities in relation to a physical location has been described as including a platform and various services, APIs, etc. These may be implemented by one or more processors executing instructions stored in one or more memories. Each memory may be random access memory (RAM), read-only memory (ROM), flash memory or any other memory, or combination thereof, suitable for storing control software or other instructions and data. Data, such as location information 310 and user information 320, may be stored on disk in a file server or any other suitable storage device or system. Some of the functions performed by the system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be stored or delivered to a processor in many forms, including, but not limited to, information permanently stored on non-writable computer-readable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of the system have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiment(s).

What is claimed is:

1. A computer-implemented method of associating a user's activity in relation to a physical location with a virtual community, the method comprising:
receiving from a personal communication device of the user a message by which is indicated the user's participation in the activity at the location;
dynamically updating a location profile associated with the physical location to reflect information inherent in the message; and
retrieving data in such updated profile and making the retrieved data available to an audience over the Internet.

2. A method according to claim 1, wherein the message is formatted in accordance with a protocol for identifying the location and the activity, the method further comprising:
using a computer process to extract from the message, in a manner dictated by the protocol, the location and the activity.

3. A method according to claim 1, wherein making data in such updated profile available includes making at least a portion of such profile available via a virtual community web site.

4. A method according to claim 1, wherein the activity includes presence of the user at the location and dynamically updating the location profile includes identifying presence of the user.

5. A method according to claim 1, further comprising:
making available, via messaging to a personal communication device of another user who has provided a message by which is indicated participation of such other user in the activity at the location, data identifying the user whose message indicated the user's participation in the activity at the location.

6. A method according to claim to claim 1, further comprising:
providing a facility permitting the user to post a message, via the user's personal communication device, to other users, each of who has provided a message by which is indicated participation of such other user in the activity at the location.

7. A method according to claim to claim 1, further comprising:
making available, via messaging to the personal communication device of the user, identities of other users, each of who has provided a message by which is indicated participation of such other user in the activity at the location; and
providing a facility permitting the user to post a message, via the user's personal communication device, to an identified other user who has been selected by the user.

8. A method according to claim to claim 1, further comprising:
making available, via messaging to the personal communication device of the user, identities of others, each of user who has provided a message by which is indicated participation of such other user in the activity at the location; and
providing a facility permitting the user to post a message, via the user's personal communication device, to each identified other user who has been selected by the user.

9. A method according to claim to claim 1, further comprising:
providing a facility for at least one networked interactive device at the physical location, the at least one networked interactive device being capable of being controlled or accessed by the personal communication device of the user; and
providing status information about the at least one networked interactive device to the audience over the Internet.

10. A method according to claim 9, wherein the at least one networked interactive device includes a jukebox.

11. A method according to claim 9, wherein the at least one networked interactive device includes a display screen visible to individuals present at the location.

12. A method according to claim 9 or claim 10 or claim 11, wherein the at least one networked interactive device comprises a plurality of networked interactive devices.

13. A system for associating a user's activity in relation to a physical location with a virtual community, the system comprising:
a first data interface configured to receive a message originated by a personal communication device of the user, wherein receipt of the message indicates the user's participation in the activity at the location;
data storage configured to store a location profile associated with the physical location;
a server coupled to the first data interface and to the data storage and configured, in response to receipt of the message, to update the location profile associated with the physical location to reflect information inherent in the message; and
a second data interface coupled to the server and configured to make data in such updated location profile available to an audience over the Internet.

14. A system according to claim 13, wherein the second data interface includes a web server.

15. A system according to claim 13, wherein the second data interface includes an interface to a social networking system.

16. A system according to claim 13, wherein the second data interface includes an interface to a virtual community web site.

17. A system according to claim 13, wherein the second data interface includes an interface to a wireless communication network that includes a plurality of wireless personal communication devices.

18. A system according to claim 13, wherein:
the message is formatted in accordance with a protocol for identifying the location and the activity; and
the server is further configured, in response to receipt of the message, to extract from the message, in a manner dictated by the protocol, the location and the activity.

19. A system according to claim 13, wherein the activity includes presence of the user at the location; and the server is configured, in response to receipt of the message, to update the location profile by identifying the presence of the user.

20. A system according to claim 13, wherein the server is configured to make available, via messaging to a personal communication device of another user who has provided a message by which is indicated participation of such other user in the activity at the location, data identifying the user whose message indicated the user's participation in the activity at the location.

21. A system according to claim 13, wherein:
the first data interface is configured to receive a message originated by a personal communication device of the user, wherein the message comprises text;
the first data interface is configured to receive messages originated by personal communication devices of other users, wherein receipt of the messages indicates the respective other users' participations in the activity at the location; and
the server is configured to send messages containing copies of the text to the personal communication devices of the respective other users.

22. A system according to claim 13, wherein:
the server is configured to make available, via messaging to the personal communication device of the user, identities of other users, each of who has provided a message by which is indicated participation of such other user in the activity at the location;
the first data interface is configured to receive a message originated by a personal communication device of the user, wherein the message comprises text;
the server is configured to send a message containing a copy of the text to the personal communication device of an identified other user who has been selected by the user.

23. A system according to claim 13, wherein:
the server is configured to make available, via messaging to the personal communication device of the user, identities of other users, each of who has provided a message by which is indicated participation of such other user in the activity at the location;
the first data interface is configured to receive a message originated by a personal communication device of the user, wherein the message comprises text;
the server is configured to send a message containing a copy of the text to the personal communication device of each identified other user who has been selected by the user.

24. A system according to claim 13, further comprising:
a third data interface configured to receive communications from at least one networked interactive device at the physical location, the at least one networked interactive device being capable of being controlled or accessed by the personal communication device of the user; and wherein:
the server is configured to provide status information about the at least one networked interactive device to the audience over the Internet.

25. A system according to claim 24, wherein the at least one networked interactive device includes a jukebox.

26. A system according to claim 24, wherein the at least one networked interactive device includes a display screen visible to individuals present at the location.

27. A system according to claim 24, to claim 25 or claim 26, wherein the at least one networked interactive device comprises a plurality of networked interactive devices.

28. A method for providing interactive displays, the method comprising:
making available, from an IP address, web pages for serving over a first network:
to a plurality of network addressable screens, each screen being addressable via the first network, so as to provide contents particularized to each of the screens; and
to other computers coupled to the first network in communication with the IP address;
translating commands received over a second network from user communication devices and using the translated commands to affect contents on the screens, wherein each user communication device separately affects contents on a selected one of the screens; and
aggregating contents from a selected plurality of the screens and providing the aggregated contents to a selected one or more of the screens.

29. A method according to claim 28, further comprising providing, in association with a portion of the aggregated contents, information about a user from whose user communication device was received the command that affected the portion of the aggregated contents.

30. A method according to claim 29, wherein the information about the user includes a location associated with the user.

31. A method according to claim 29, wherein the information about the user includes a location associated at least a portion of a telephone number of the user communication device.

32. A method according to claim 29, wherein the information about the user includes a location associated the selected one of the screens affected by the user's user communication device.

33. A method according to claim 29, wherein the information about the user includes a code used by the user communication device to identify the selected one of the screens.

34. A method according to claim 29, wherein the information about the user includes an identification of a service, via which the commands were carried.

35. A method according to claim 28, wherein aggregating the contents comprises selecting contents to aggregate based on the selected one or more of the screens.

36. A method according to claim 28, wherein aggregating the contents comprises aggregating the contents, such that which contents are made available to which screens depends on information about the location of the screen to which the contents are to be made available.

37. A method according to claim 28, wherein aggregating the contents comprises aggregating the contents, such that which contents are made available to which screens depends on information about the location of the screen from which the contents are aggregated.

38. A computer-implemented method of associating a user's activity in relation to a physical location with a virtual community, the method comprising:
receiving a plurality of messages, each message from a respective personal communication device of a respective user and indicating the respective user's participation in a respective activity in relation to a respective location among a plurality of locations;
for each message, dynamically updating a location profile associated with the respective location to reflect information inherent in the message;
for each respective location, retrieving data in such updated profile and making the retrieved data available to an audience over the Internet so that users in the plurality of locations have access to a common experience via the Internet.

39. A method according to claim 38, wherein making the retrieved data available to an audience includes causing display of the retrieved data on a display at each of at least one of the respective locations.

40. A method according to claim 39, wherein making the retrieved data available to an audience includes causing display of the retrieved data on a display at each of a plurality of the respective locations.

41. A method according to claim 38, wherein each respective activity in relation to the respective location includes interaction of the respective user with a display at the respective location.

42. A jukebox, comprising:
a display screen;
a music playing subsystem;
a network interface; and
a processor coupled to the display screen, the music playing subsystem and the network interface and programmed to:
receive, via the network interface, information about first songs selected for play on other jukeboxes; and
display the information on the display screen.

43. A jukebox according to claim 42, wherein the processor is further programmed to:
receive a user selection of a subset of the information displayed on the screen; and
cause the music playing subsystem to play a second song based on the user selection.

44. A jukebox according to claim 43, wherein:
the information about the first songs includes titles of the first songs; and
the second song has a title identical to a first song.

45. A jukebox according to claim 44, wherein:
the user selection includes a first song title; and
the second song has a title identical to the selected first song title.

46. A jukebox according to claim 42, wherein the processor is further programmed to:
receive a user selection of a subset of the information displayed on the screen; and
display information about at least one third song based on the user selection.

47. A jukebox according to claim 46, wherein:
the user selection includes identification of an artist; and
the at least one third song is associated with the identified artist.

48. A jukebox according to claim 46, wherein:
the user selection includes identification of another user who selected a first song; and
the at least one third song was selected by the selected another user.

49. A jukebox according to claim 46, wherein:
the user selection includes identification of at least one of the other jukeboxes; and
the at least one third song was selected for play on the selected other jukebox.

50. A method for operating a jukebox, comprising:
receiving information about first songs selected for play on other jukeboxes; and
display the information on a display screen of the jukebox.

51. A method according to claim 50, further comprising:
receiving a user selection of a subset of the information displayed on the screen; and
causing the jukebox to play a second song based on the user selection.

52. A method according to claim 50, further comprising:
receiving a user selection of a subset of the information displayed on the screen; and
displaying information about at least one third song based on the user selection.
